(19) United States
(12) Patent Application Publication
(10) Pub. No.: US 2009/0015177 A1
(43) Pub. Date: Jan. 15, 2009

(54) POWER SUPPLY DEVICE AND LIGHT-EMITTING DEVICE AND ELECTRONIC EQUIPMENT USING SUCH POWER SUPPLY DEVICE

(75) Inventor: Kenichi Fukumoto, Kyoto (JP)

Correspondence Address: CANTOR COLBURN, LLP, 20 Church Street, 22nd Floor, Hartford, CT, 06103, US

(73) Assignee: ROHM CO., LTD., Kyoto (JP)

(21) Appl. No.: 12/162,239

(22) PCT Filed: Jan. 25, 2007
(86) PCT No.: PCT/JP2007/000030

§ 371 Date: Jul. 25, 2008

(30) Foreign Application Priority Data
Jan. 25, 2006 (JP) JP2006-016964

(51) Int. Cl. G05F 1/00

(52) U.S. Cl. 315/294

(57) ABSTRACT

In a power supply apparatus for supplying a power to a plurality of CCFLs, a plurality of transformers are provided for the respective CCFLs. Respective primary coils of the transformers are connected to each other in series so as to constitute one current path. One ends of respective secondary coils of the transformers are connected to the plurality of loads. An AC power supply unit generates an AC voltage and applies the AC voltage to the other ends of the secondary coils of the plurality of transformers. A capacitor is disposed on the current path formed with the primary coils of the transformers. A first fixed voltage is applied to one end of the current path, and a second fixed potential different from the first fixed voltage is applied to the other end of the current path.

### BACKGROUND OF THE INVENTION

1. Field of the Invention

The present invention relates to a power supply apparatus for supplying an AC power to loads such as fluorescent lamps.

2. Description of the Related Art

Recently, as a substitute for CRT TVs, thin, wide screen liquid crystal televisions have been widely provided. As a backlight for the liquid crystal TV, a plurality of cold cathode fluorescent lamps (hereinafter, referred to as CCFLs) or a plurality of external electrode fluorescent lamps (hereinafter, referred to as EEFLs) are disposed on a rear surface of a liquid crystal panel on which images are displayed.

An inverter (DC/AD converter) which boosts up a DC voltage of about 12V and outputs an AD voltage is used for driving the CCFL and the EEFL. The inverter converts an electric current flowing through the CCFL to a voltage and feeds the voltage back to a control circuit, so that turning-on and turning-off of a switching element are controlled based on the feedback voltage. The technologies for driving the CCFL are disclosed in Patent Documents 1 and 2.

[Patent Document 1] Japanese Patent Application Laid-Open No. 2003-323994

[Patent Document 1] Japanese Patent Application Laid-Open No. 2003-323994

Now, a case where a plurality of CCFLs are driven by using an AC voltage boosted by an inverter. Luminance of each CCFL is determined depending on a current flowing through the CCFL. In order to obtain uniform luminance of the plurality of CCFLs, the currents flowing through the CCFLs need to be equalized.

### SUMMARY OF THE INVENTION

The present invention has been made in view of above problems. A general purpose of the present invention is to provide a power supply apparatus for supplying a power uniformly to a plurality of loads such as CCFLs.

According to an embodiment of the present invention, there is provided a power supply apparatus for supplying a power to a plurality of loads. The power supply apparatus comprises: a plurality of transformers which are provided for the respective loads, wherein respective primary coils of the transformers are connected to each other in series so as to constitute one current path, and one ends of respective secondary coils of the transformers are connected to the plurality of loads; an AC power supply unit which generates an AC voltage and applies the AC voltage to other ends of the secondary coils of the plurality of transformers; and a capacitor which is disposed on the current path which is formed with the primary coils of the transformers. A first fixed voltage is applied to one end of the current path, and a second fixed potential different from the first fixed voltage is applied to the other end of the current path.

According to the embodiment, since the same current (hereinafter, referred to as a common current) flows through the primary coils of the plurality of transformers, currents obtained by multiplying the common current with a primary/secondary winding ratio flow through the secondary coils of respective transformers. As a result, the power supplied to the plurality of loads can be controlled based on the winding ratios. In addition, the both ends of the current path through which the common current flows are fixed at different voltages, so that the common current can be sensed.

According to the embodiment, the power supply apparatus may further comprises a current sensing circuit which is disposed on the current path to sense a current flowing through the current path. The AC power supply unit may control the power supplied to the loads by taking the current sensed by the current sensing circuit as the current flowing through the plurality of loads.

In a case where the loads are CCFLs or the like, a sum of the currents flowing through the loads such as CCFLs and currents flowing through parasite capacitors formed between wire lines and a circuit board flow through the secondary coils of the transformers. Therefore, if the power supplied to the loads is controlled based on the currents flowing through the secondary coils, currents excessively larger than the currents actually flowing through the loads are estimated. According to the embodiment, since the power supplied to the loads are controlled based on the current flowing through the current path formed with the primary coils, the power can be controlled more accurately.

The AC power supply unit may perform feedback control of the power supplied to the plurality of loads so that the current sensed by the current sensing circuit is equal to a desired current value.

The AC power supply unit may perform a predetermined process if the current sensed by the current sensing circuit is less than a predetermined threshold value. In this case, since the turned-off state of the lamps can be sensed, it is possible to perform a circuit protection operation or a process for re-turning on the lamps.

The current sensing circuit may include a current sensing resistor which is disposed on the current path, and a potential at one end thereof is fixed. The AC power supply unit may to control the power supplied to the loads by taking a voltage drop across the current sensing resistor as a signal according to the current flowing through the plurality of loads.

The current sensing circuit may further include a filter which performs half-wave rectification on the voltage drop across the current sensing resistor to extract a DC component. The AC power supply unit may perform feedback control of the power supplied to the plurality of loads so that an output voltage of the filter is equal to a voltage value corresponding to a desired current value.

The power supply apparatus may further comprise a first abnormality sensing circuit which compares an amplitude of the voltage drop across the current sensing resistor with a predetermined threshold value and notifies a circuit abnormality to the AC power supply unit when the amplitude of the voltage drop is less than the threshold value. The AC power supply unit may perform a predetermined process when the circuit abnormality is notified by the first abnormality sensing circuit.

One end of the current sensing resistor may be connected to the first fixed voltage, and the first abnormality sensing circuit may include: a comparator which compares a voltage at the other end of the current sensing resistor with the threshold voltage; a pull-up resistor which pulls up an output of the comparator having an open collector structure to a high level; and a capacitor which is disposed between the output of the comparator and a ground. A state that the output of the comparator is in the high level may be notified as the circuit abnormality to the AC power supply unit.

The power supply apparatus may further comprise a second abnormality sensing circuit which monitors voltages of one-end portions of the primary coils of the plurality of transformers and notifies a circuit abnormality to the AC power supply unit when a potential at at least one end is less than a predetermined threshold voltage. The AC power supply unit may decrease the power supplied to the plurality of loads when the circuit abnormality is notified by the second abnormality sensing circuit.

The power supply apparatus may further comprise an excessive voltage sensing circuit which monitors voltages of connection points of the secondary coils of the plurality of transformers and the plurality of loads and notifies an excessive voltage state to the AC power supply unit when a potential at at least one of the connection points is larger than the threshold voltage. The AC power supply unit may decrease the power supplied to the plurality of loads when the excessive voltage state is notified by the excessive voltage sensing circuit.

According to another embodiment of the present invention, there is provided a power supply apparatus for supplying a power to a plurality of loads. The power supply apparatus comprises: a plurality of transformers which are provided for the respective loads, wherein respective primary coils of the transformers are connected to each other in series so as to constitute one current path, and one ends of respective secondary coils of the transformers are connected to the loads; an AC power supply unit which generates an AC voltage and applies the AC voltage to other ends of the secondary coils of the plurality of transformers; and a current sensing circuit which is disposed on the current path to sense a current flowing through the current path. The AC power supply unit controls the power supplied to the loads by taking the current sensed by the current sensing circuit as the current flowing through the plurality of loads.

According to the embodiment, since the power supplied to the loads is controlled based on the current flowing through the current path formed with the primary coils, it is possible to more accurately control the power in comparison with a case where the power is controlled based on the currents flowing through the secondary coils.

The AC power supply unit may be an inverter which converts an input DC voltage to an AC voltage and outputs the AC voltage.

According to still another embodiment of the present invention, there is provided a light-emitting apparatus. The light-emitting apparatus comprises: a plurality of fluorescent lamps; and the aforementioned power supply apparatus, which supplies a power to the plurality of fluorescent lamps as plurality of loads. The fluorescent lamps may be cold cathode fluorescent lamps or external electrode fluorescent lamps.

According to the embodiment, it is possible to control the luminance of the fluorescent lamps according to the winding ratios of the plurality of transformers.

According to still another embodiment of the present invention, there is provided an electronic apparatus. The electronic apparatus comprises: a liquid crystal panel; and the aforementioned light-emitting apparatus, which is disposed as a backlight on a rear surface of the liquid crystal panel.

According to the embodiment, it is possible to reduce irregularity of luminance of the liquid crystal panel.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a circuit diagram illustrating a construction of a light-emitting apparatus according to an embodiment of the present invention;

FIG. 2 is a block diagram illustrating a construction of a liquid crystal TV provided with the light-emitting apparatus of FIG. 1;

FIG. 3 is a circuit diagram illustrating a portion of a construction of a power supply apparatus having a current sensing function;

FIG. 4 is a circuit diagram illustrating an example of a construction of a current sensing circuit for performing a first power control;

FIG. 5 is a circuit diagram illustrating an example of a construction of a current sensing circuit for performing a second power control;

FIG. 6 is a voltage waveform view for explaining operations of a first abnormality sensing circuit of FIG. 5; and

FIG. 7 is a circuit diagram illustrating an example of a construction of a power supply apparatus of an embodiment where a circuit protection function is reinforced.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

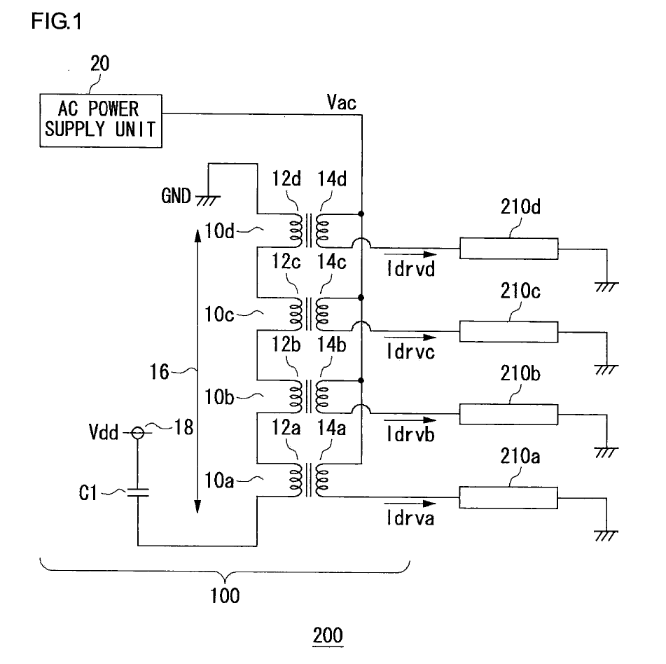

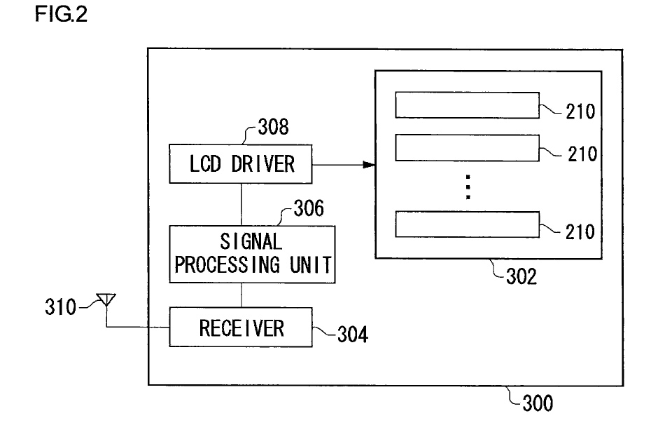

FIG. 1 is a circuit diagram illustrating a construction of a light-emitting apparatus 200 according to an embodiment of the present invention. The light-emitting apparatus 200 according to the embodiment is used as a backlight of a liquid crystal panel. FIG. 2 is a block diagram illustrating a construction of a liquid crystal TV 300 provided with the light-emitting apparatus 200 of FIG. 1. The usage of the light-emitting apparatus 200 according to the embodiment other than the liquid crystal TV may be a notebook personal computer and the like.

Referring to FIG. 2, the liquid crystal TV 300 is connected to an antenna 310. The antenna 310 receives a broadcasting wave and outputs a received signal to a receiver 304. The receiver 304 senses and amplifies the received signal and outputs the received signal to a signal processing unit 306. The signal processing unit 306 outputs to a liquid crystal driver 308 an image data which can be obtained by demodulating a modulated data. The liquid crystal driver 308 outputs the image data to a liquid crystal panel 302 through each scan line to display an image. As a backlight, a plurality of CCFLs 210 are disposed on a rear surface of the liquid crystal panel 302. A later-described power supply apparatus according to the embodiment is used for supplying a power to the plurality of CCFLs 210.

Now, a construction and operations of the power supply apparatus according to the embodiment are described in detail with reference again to FIG. 1.

The light-emitting apparatus 200 according to the embodiment includes the power supply apparatus 100 and the plurality of CCFLs 210a to 210d which are provided as loads for the power supply apparatus. Hereinafter, the CCFLs 210a to 210d may be collectively referred to as CCFLs 210 if needed. In the embodiment, four CCFLs are provided, but the present invention is not limited thereto.

The CCFLs 210 are disposed on the rear surface of the liquid crystal panel of FIG. 2. The power supply apparatus 100 supplies a power to the plurality of CCFLs 210. For example, the power supply apparatus generates an AC voltage of 1000V or more to supply the AC voltage to the CCFLs 210. Luminance of each of the CCFLs 210 is determined based on a current flowing through each of the CCFLs. A variation in driving currents causes an irregularity of luminance of the backlight. For this reason, the power supply apparatus 100 is required to uniformly drive the plurality of CCFLs 210.

The power supply apparatus 100 includes a first to fourth transformers 10a to 10d, a capacitor C1, an AC power supply unit 20.

The first to fourth transformers 10a to 10d are provided for each of the CCFLs 210a to 210d. Hereinafter, affixes a to d may not be attached if needed, and first to fourth transformers 10a to 10d may be collectively referred to as transformers 10. Each of the transformers 10 includes a primary coil 12 and a secondary coil 14. The primary coils 12a to 12d of the first to fourth transformers 10a to 10d are connected to each other in series to constitute one current path 16. One end of each of the secondary coils of first to fourth transformers 10a to 10d is connected to each of the plurality of CCFLs 210a to 210d.

The AC power supply unit 20 generates an AC voltage Vac and applies the AC voltage to the other end (that is, an end opposite to the end connected to each of the CCFLs 210a to 210d) of each of the secondary coils 14a to 14d of the first to fourth transformers 10a to 10d.

For example, the AC power supply unit 20 is an inverter which converts an input DC voltage (for example, a power supply voltage) to and AC voltage Vac and outputs the AC voltage Vac. An AC power supply unit such as an inverter is well known in the related art, and thus, description thereof is not provided here.

The capacitor C1 is disposed on the current path 16, which is formed with the primary coils 12a to 12d of the first to fourth transformers 10a to 10d. With respect to the current path 16 that is constructed with the capacitor C1 and the primary coils 12a to 12d, one end thereof is connected to a power supply voltage terminal 18 to be applied with a power supply voltage as a first fixed voltage. In addition, the other end of the current path 16 is connected to a ground terminal GND to be applied with a ground potential (0V) as a second fixed voltage. Due to the capacitor C1, a DC current flowing from the power supply voltage terminal 18 to the ground terminal GND is blocked, and an AC common current Icom described later flows through the current path 16.

Next, operations of the power supply apparatus 100 according to the embodiment are described. The AC voltage Vac is generated by the AC power supply unit 20 and applied to one end of each of the primary coils 12 of the first to fourth transformers 10a to 10d. The AC voltage Vac applied to the one end of each of the primary coil 12 is applied through the primary coil 12 to each of the CCFLs 210a to 210d as loads. The CCFLs 210 emit light by using the AC voltage Vac applied as driving voltages, and thus, the driving currents Idrva to Idrvd flow through the CCFLs 210. The driving currents Idrva to Idrvd flowing through each of the CCFLs 210 are supplied by the AC power supply unit 20 through the secondary coils 14.

As a result, the driving currents Idrv flowing through the CCFLs 210 flow through the secondary coils 14a to 14d of the first to fourth transformers 10a to 10d which are disposed for the respective CCFLs 210a to 210d. The primary coils and secondary coils of the transformers are coupled to each other, and a current according to the winding ratio N flows through each of the coils. Therefore, a current Idrv/N flows through each of the primary coils of the first to fourth transformers 10a to 10d.

As described above, sine each the primary coils 12 of the transformers 10 constitute the same current path, the currents flowing through the coils are equal to each other. In the embodiment, the current is referred to as a common current Icom. In other words, the driving currents Idrv through the CCFLs 210 and the common current Icom satisfy a relationship Idrv=Icom×N.

According to the power supply apparatus 100 of the embodiment, the power supplied to the plurality of CCFLs 210 can be controlled according to a winding ratio N, so that the plurality of CCFLs 210 emit light with desired relative luminance. For example, winding ratios of all the transformers 10 may be set to be the same value, or alternatively, the winding ratios N may be changed according to positions of the CCFLs 210 with respect to the liquid crystal panel.

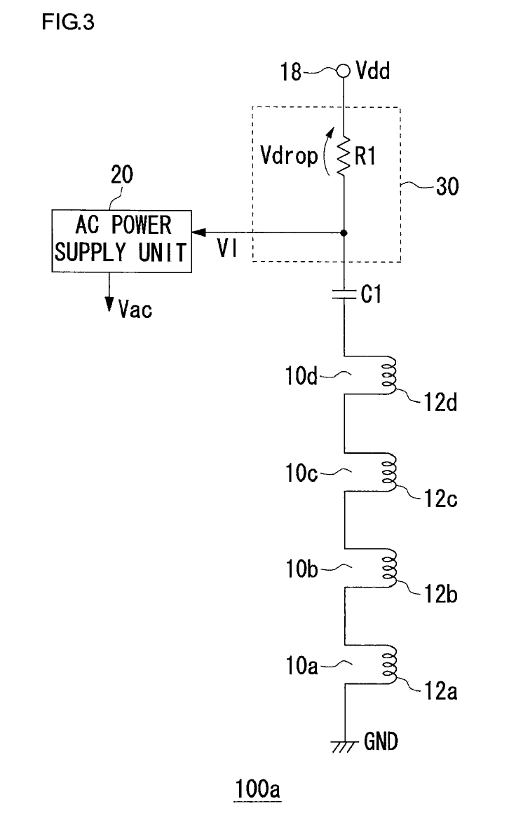

In addition, according to the power supply apparatus 100 of the embodiment, since both ends of the current path 16 through which the common current Icom flows are fixed at different potentials, the common current Icom can be sensed. Hereinafter, a sensing method for the common current Icom is described with reference to FIG. 3.

FIG. 3 is a circuit diagram illustrating a portion of construction of the power supply apparatus having a current sensing function. The power supply apparatus 100a of FIG. 3 includes a current sensing circuit 30 which is disposed on the current path 16 and senses the common current Icom. According to the embodiment, the current sensing circuit 30 includes a current sensing resistor R1. The current sensing resistor R1 is disposed on the current path 16, and one end thereof is connoted to the power supply voltage terminal 18, so that a potential at the one end is fixed. A voltage drop across the current sensing resistor R1 is represented as R1×Icom by using the common current Icom. In the specification, the reference numerals provided for the voltage signals, the current signals, the resistors, the capacitors, or the like may denote voltage values, current values, resistances, capacitances, or the like, respectively.

A potential VI at the other end of the current sensing resistor R1 is lowered by the voltage drop Vdrop and represented as VI=Vdd−R1×Icom. Hereinafter, the potential at the other end of the current sensing resistor R1 is referred to as a sensed voltage VI. The current sensing circuit 30 outputs the sensed voltage VI to the AC power supply unit 20. In addition, the current sensing resistor R1 may be disposed with a potential of one end fixed and many be disposed at the ground terminal side.

The AC power supply unit 20 takes the voltage drop across the current sensing resistor R1 as a signal according to currents flowing through the plurality of CCFLs 210 to control the power supplied to the CCFLs 210. Next, very suitable examples of the power control performed by the AC power supply unit 20 are described.

(First Power Control Scheme)

The AC power supply unit 20 performs a feedback control of the power supplied to the CCFLs 210 so that the current sensed by the current sensing circuit 30 is equal to a desired current value Iref.

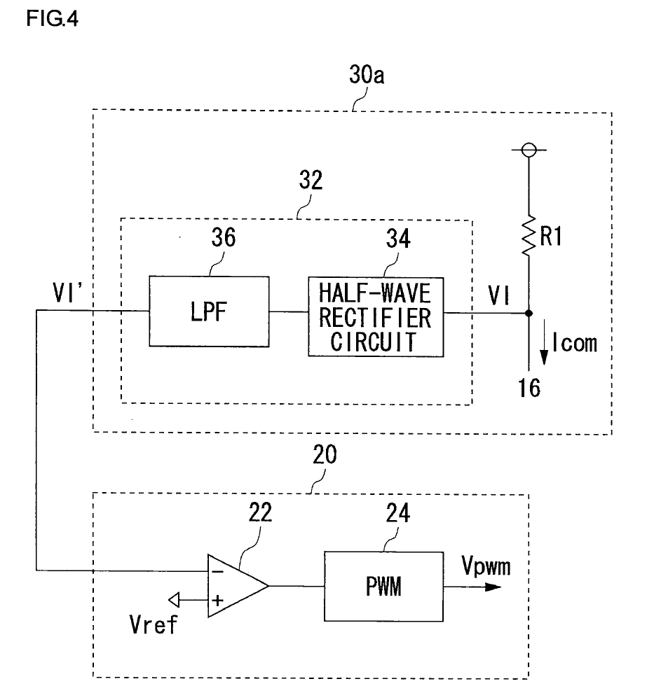

FIG. 4 is a circuit diagram illustrating an example of a construction of a current sensing circuit 30a for performing a first power control. The current sensing circuit 30a includes a filter 32 in addition to the current sensing resistor R1. The filter 32 performs half-rectification on the voltage drop Vdrop across the current sensing resistor R1 to extract a DC component. For example, the filter 32 may be constructed with a lowpass filter 36 which includes a half-wave rectifier circuit 34 using a diode, a resistor, and a capacitor.

The filter 32 outputs a feedback voltage VI′ according to an amplitude of the voltage drop Vdrop across the current sensing resistor R1, that is, an amplitude of the common current Icom.

The AC power supply unit 20 performs feedback control of the power supplied to the CCFLs 120 so that the output voltage VI′ of the filter 32 is equal to a voltage Vref corresponding to the desired current value Iref. The control may be performed using various known feedback control techniques. Although FIG. 4 illustrates an example of controlling the power supplied to the loads using pulse width modulation (PWM), the control may be performed by adjusting a frequency of the AC voltage Vac.

The AC power supply unit 20 includes an error amplifier 22 and a pulse width modulator 24. The error amplifier 22 amplifies an error between the feedback voltage VI′ and the reference voltage Vref and output an error voltage Verr. The pulse width modulator 24 compares the error voltage Verr with a periodic voltage having a triangular or sawtooth shape and outputs a pulse signal Vpwm of which pulse width is varied according to an inequality relationship thereof. The AC power supply unit 20 controls a switching operation of a switching circuit such as an H bridge circuit disposed on the following stage according to the pulse width of the pulse signal Vpwm.

In a case where the loads are CCFLs or the like, a sum of the currents Idrv flowing through the loads, such as CCFLs 210 or the like and currents flowing through parasite capacitors (not shown) formed between wire lines and a circuit board or the like flow through the secondary coils 14 of the transformers 10. Therefore, if the currents flowing through the secondary coils 14 is monitored and based on the currents the power supplied to the CCFLs 210 is controlled, currents excessively larger than the currents actually flowing through the CCFLs 210 are estimated.

However, according to the first power control scheme, since the power supplied to the loads are controlled based on the common current Icom flowing through the current path 16 formed with the primary coils 12, the power can be controlled more accurately.

(Second Power Control Scheme)

The AC power supply unit 20 may perform a predetermined process if the current sensed by the current sensing circuit 30 is less than a predetermined threshold value.

FIG. 5 is a circuit diagram illustrating an example of a construction of a current sensing circuit for performing a second power control. The current sensing circuit 30b of FIG. 5 includes a first abnormality sensing circuit 40, which compares the amplitude of the voltage drop Vdrop across the current sensing resistor R1 with the threshold value, in addition to the current sensing resistor R1. The first abnormality sensing circuit 40 notifies circuit abnormality to the AC power supply unit 20 if the amplitude of the voltage drop Vdrop is less than the threshold value Vth.

The first abnormality sensing circuit 40 includes a comparator 42, a pull-up resistor R2, and a capacitor C2. A sensed voltage VI is input to a non-inverted terminal of the first abnormality sensing circuit 40, and the threshold voltage Vth is input to an inverted terminal thereof. The comparator 42 has an open collector structure, and an output thereof is pulled up to a high level as the power supply voltage or the like by the pull-up resistor R2. The capacitor C2 is disposed between the output of the comparator 42 and the ground.

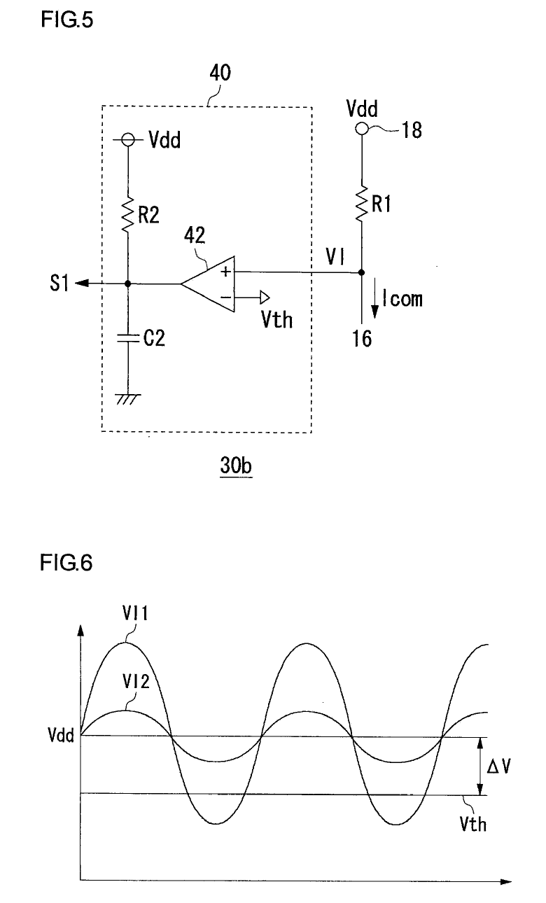

FIG. 6 is a voltage waveform view for explaining operations of the first abnormality sensing circuit of FIG. 5. The sensed voltage VI is a sine wave having the power supply of almost the voltage Vdd as a central value. When the amplitude of the common current Icom flowing through the current path 16 increases, the amplitude of the sensed voltage VI also increases. As indicated by VI1 in FIG. 6, if the amplitude of the sensed voltage VI is larger than a potential difference ΔV between the power supply voltage Vdd and the threshold voltage Vth, the sensed voltage VI is less than the threshold voltage Vth, accordingly the output S1 of the comparator 42 becomes a low level.

On the contrary, as indicated by VI2 in FIG. 6, if the amplitude of the sensed voltage VI is smaller, the output S1 of the comparator 42 is pulled up to the high level. For example, if some of the CCFLs 210 are turned off, the amplitude of the common current Icom becomes small, accordingly the output S1 of the comparator 42 becomes the high level. In this manner, the first abnormality sensing circuit 40 takes the state that the output S1 of the comparator 42 is in the high level as the circuit abnormality such as the turn-off of the CCFLs 210 and notifies the circuit abnormality to the AC power supply unit 20.

When the circuit abnormality is notified by the first abnormality sensing circuit 40, the AC power supply unit 20 decreases the power supplied to the CCFLs 210 and performs a required circuit protection operation or a process for re-turning on the CCFLs 210. With the similar construction, an excessive current state can be sensed.

According to the power supply apparatus 100 of the embodiment, as described in the first and second power control schemes, one current path 16 is constructed with the primary coils 12 of the transformers 10, and the common current Icom is monitored, so that it is possible to perform various control according to the common current Icom, that is, the driving current Icom of the CCFLs 210. The first and second power control schemes may be individually performed. Alternatively, the first and second power control schemes may be simultaneously performed. In addition, the power control scheme is not limited to the first and second power control schemes, but present invention may be used for various control schemes.

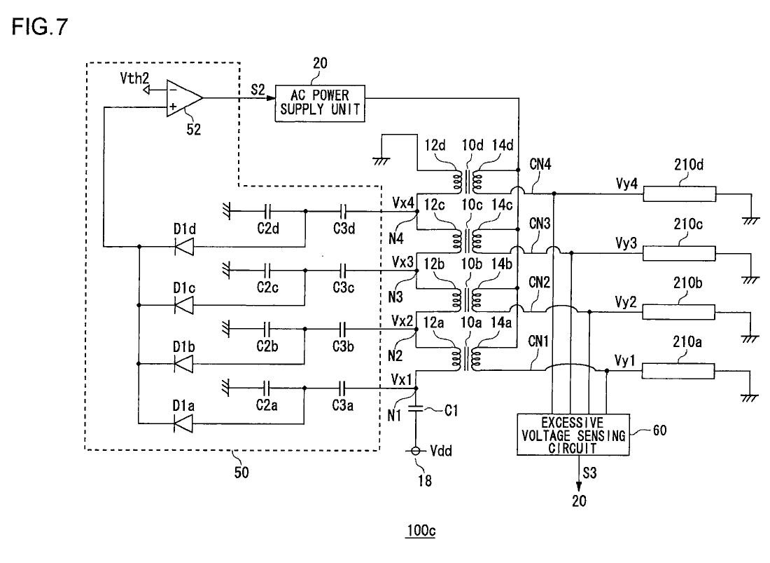

FIG. 7 is a circuit diagram illustrating an example of a construction of a power supply apparatus related to an embodiment where a circuit protection function is reinforced. The power supply apparatus 100c of FIG. 7 further includes a second abnormality sensing circuit 50 and an excessive voltage sensing circuit 60.

The second abnormality sensing circuit 50 monitors voltages Vx1 to Vx4 of terminals N1 to N4 of the primary coils of the plurality of transformers 10 and notifies circuit abnormality to the AC power supply unit 20 if the potential Vx at at least one of the connection points is less than a predetermined threshold voltage Vth2.

The second abnormality sensing circuit 50 includes voltage-dividing capacitors C2, C3 and a diode D1 for each of terminals N1 to N4. The capacitors C2 and C3 are connected to each other in series between each of the terminals N and the ground to divide the voltage Vn of each of the terminals N. The anode of the diode D1 is connected to a connection point of the capacitors C2, C3. The cathodes of the diodes D1a to Did disposed for the respective terminals N1 to N4 are commonly connected, and then a signal is input to the non-inverted input terminal of the comparator 52. The comparator 52 compares the potentials of the cathodes of the cathodes D1a to D1d with a threshold voltage Vth2. If a potential Vx at at least one connection point is less than the threshold voltage Vth, an output S2 of the comparator 52 becomes the high level, and the circuit abnormality is notified to the AC power supply unit 20. When the circuit abnormality is notified by the second abnormality sensing circuit 50, the AC power supply unit 20 decreases the power supplied to the CCFLs 210.

The excessive voltage sensing circuit 60 monitors voltages Vy1 to Vy4 of the connection points CN1 to CN4 of the secondary coils 14a to 14d of plurality of the transformers 10 and the CCFLs 210a to 210d and notifies the excessive voltage state to the AC power supply unit 20 by setting the output signal S3 to the high level if the potential at at least one of the connection points is larger than the threshold voltage. The internal construction of the excessive voltage sensing circuit 60 may be the same as that of the second abnormality sensing circuit 50, and thus, description thereof is not repeated. When the excessive voltage state is notified by the excessive voltage sensing circuit 60, the AC power supply unit 20 decreases the power supplied to the CCFLs 210.

The embodiment is an exemplary one. It can be understood by the ordinarily skilled in the art that various modifications in combination of components and processes are available and the modifications are also within the scope of the present invention.

In the embodiment, the setting of the high and low level of the logic level signal is exemplary one, but the setting may be freely modified through suitable inversion by an inverter or the like.

In the embodiment, although the driving voltages are supplied to one end of the CCFLs 210 in the light-emitting apparatus 200, the present invention is limited thereto. For example, the power supply apparatus 100 may be connected to both ends of each of the CCFLs 210, and the CCFLs 210 may be driven with an inverted phase of the driving voltage. In addition, a U-shaped CCFLs may be used as the CCFLs 210. The to-be-driven fluorescent lamp is not limited to the CCFL, but other types of fluorescent lamps of EELF or the like may be used.

In addition, the loads driven by the power supply apparatus 100 according to the embodiment is not limited to the fluorescent lamps, but various devices requiring a high AC voltage may be driven by the power supply apparatus.

While the preferred embodiments of the present invention have been described using specific terms, such description is for illustrative purposes only, and it is to be understood that changes and variations may be made without departing from the spirit or scope of the appended claims.

1. A power supply apparatus for supplying a power to a plurality of loads, comprising:
a plurality of transformers which are provided for the respective loads, wherein respective primary coils of the transformers are connected to each other in series so as to constitute one current path, and one ends of respective secondary coils of the transformers are connected to the plurality of loads;
an AC power supply unit which generates an AC voltage and applies the AC voltage to other ends of the secondary coils of the plurality of transformers; and
a capacitor which is disposed on the current path which is formed with the primary coils of the transformers, wherein
a first fixed voltage is applied to one end of the current path, and a second fixed potential different from the first fixed voltage is applied to the other end of the current path.

2. The power supply apparatus according to claim 1, further comprising a current sensing circuit which is disposed on the current path to sense a current flowing through the current path, wherein
the AC power supply unit controls the power supplied to the plurality of loads by taking the current sensed by the current sensing circuit as the current flowing through the plurality of loads.

3. The power supply apparatus according to claim 2, wherein
the AC power supply unit performs feedback control of the power supplied to the plurality of loads so that the current sensed by the current sensing circuit is equal to a desired current value.

4. The power supply apparatus according to claim 2, wherein
the AC power supply unit performs a predetermined process if the current sensed by the current sensing circuit is less than a predetermined threshold value.

5. The power supply apparatus according to claim 2, wherein
the current sensing circuit includes a current sensing resistor which is disposed on the current path, and a potential at one end thereof is fixed, and
the AC power supply unit control the power supplied to the plurality of loads by taking a voltage drop across the current sensing resistor as a signal according to the current flowing through the plurality of loads.

6. The power supply apparatus according to claim 5,
wherein
the current sensing circuit further includes a filter which performs half-wave rectification on the voltage drop across the current sensing resistor to extract a DC component, and
the AC power supply unit performs feedback control of the power supplied to the plurality of loads so that an output voltage of the filter is equal to a voltage value corresponding to a desired current value.

7. The power supply apparatus according to claim 6, further comprising a first abnormality sensing circuit which compares an amplitude of the voltage drop across the current sensing resistor with a predetermined threshold value and notifies a circuit abnormality to the AC power supply unit when the amplitude of the voltage drop is less than the threshold value, wherein
the AC power supply unit performs a predetermined process when the circuit abnormality is notified by the first abnormality sensing circuit.

8. The power supply apparatus according to claim 7,
wherein
one end of the current sensing resistor is connected to the first fixed voltage,
the first abnormality sensing circuit includes:
a comparator which compares a voltage at the other end of the current sensing resistor with the threshold voltage;
a pull-up resistor which pulls up an output of the comparator having an open collector structure to a high level; and
a capacitor which is disposed between the output of the comparator and a ground, and
a state that the output of the comparator is in the high level is notified as the circuit abnormality to the AC power supply unit.

9. The power supply apparatus according to claim 1, further comprising a second abnormality sensing circuit which monitors voltages of one-end portions of the primary coils of the plurality of transformers and notifies a circuit abnormality to the AC power supply unit when a potential at at least one end is less than a predetermined threshold voltage, wherein
the AC power supply unit decreases the power supplied to the plurality of loads when the circuit abnormality is notified by the second abnormality sensing circuit.

10. The power supply apparatus according to claim 1, further comprising an excessive voltage sensing circuit which monitors voltages of connection points of the secondary coils of the plurality of transformers and the plurality of loads and notifies a excessive voltage state to the AC power supply unit when a potential at at least one of the connection points is larger than the threshold voltage,
wherein
the AC power supply unit decreases the power supplied to the plurality of loads when the excessive voltage state is notified by the excessive voltage sensing circuit.

11. A power supply apparatus for supplying a power to a plurality of loads, comprising:
a plurality of transformers which are provided for the respective loads, wherein respective primary coils of the transformers are connected to each other in series so as to constitute one current path, and one ends of respective secondary coils of the transformers are connected to the loads;
an AC power supply unit which generates an AC voltage and applies the AC voltage to other ends of the secondary coils of the plurality of transformers; and
a current sensing circuit which is disposed on the current path to sense a current flowing through the current path, wherein
the AC power supply unit controls the power supplied to the loads by taking the current sensed by the current sensing circuit as the current flowing through the plurality of loads.

12. The power supply apparatus according to claim 1, wherein
the AC power supply unit is an inverter which converts an input DC voltage to an AC voltage and outputs the AC voltage.

13. A light-emitting apparatus comprising:
a plurality of fluorescent lamps; and
the power supply apparatus according to claim 1, which supplies a power to the plurality of fluorescent lamps as plurality of loads.

14. The light-emitting apparatus according to claim 13, wherein
the fluorescent lamps are cold cathode fluorescent lamps.

15. The light-emitting apparatus according to claim 13, wherein
the fluorescent lamps are external electrode fluorescent lamps.

16. An electronic apparatus comprising:
a liquid crystal panel; and
the light-emitting apparatus according to claim 13, which is disposed as a backlight on a rear surface of the liquid crystal panel.

17. The power supply apparatus according to claim 11, wherein
the AC power supply unit is an inverter which converts an input DC voltage to an AC voltage and outputs the AC voltage.

18. A light-emitting apparatus comprising:
a plurality of fluorescent lamps; and
the power supply apparatus according to claim 11, which supplies a power to the plurality of fluorescent lamps as plurality of loads.

19. The light-emitting apparatus according to claim 18, wherein
the fluorescent lamps are cold cathode fluorescent lamps.

20. The light-emitting apparatus according to claim 18, wherein
the fluorescent lamps are external electrode fluorescent lamps.

21. An electronic apparatus comprising:
a liquid crystal panel; and
the light-emitting apparatus according to claim 18, which is disposed as a backlight on a rear surface of the liquid crystal panel.
